(19) United States
(12) Patent Application Publication
(10) Pub. No.: US 2003/0235211 A1
(43) Pub. Date: Dec. 25, 2003

(54) Field abstraction layer

(75) Inventors: Sethunarayanan Thiru, Bangalore (IN); Swaminathan Jothimani, Bangalore (IN); Krishnaswamy Meenakshi Sundaram, Bangalore (IN); Ekambaram Thirumaran, Bangalore (IN); G.V.N. Ramesh, Bangalore (IN)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 10/178,204

(22) Filed: Jun. 24, 2002

(51) Int. Cl. H04J 3/16

(52) U.S. Cl. 370/469; 370/449

(57) ABSTRACT

An abstraction layer is provided as a frame work interface between field electronic devices of various protocols to integrate devices used, for example, in bulk product handling facilities. The abstraction layer provides communication between various field devices and a control application, including providing for control of the field device by the control application and data exchange between the field device and the command application.

### BACKGROUND OF THE INVENTION

1. Field of the Invention

The present invention relates generally to an abstraction layer in the form of a software interface between any of a wide variety of device protocols and a supervisory control system, in particular to a field abstraction layer between the control system application and field devices.

2. Description of the Related Art

Facilities for producing, storing and transporting liquid and gaseous bulk products work with the bulk products in batches. For example, petroleum refineries, chemical plants, and dairy plants transport their products in batches utilizing railroad cars, tank trucks and barges to move the products from manufacturing facilities to storage facilities and ultimately to dealers and retail outlets. The monitoring of the product production and monitoring of the storage of the products and monitoring of the batch transfers of the liquid and gaseous products are increasingly becoming automated. However, a substantial number of vendors are manufacturing field devices for use in the automated batch handling of such liquid and gaseous products.

Field devices which are utilized in batch loading of liquid and gaseous products to carrier devices include batch control units, video display units, weigh bridges or weigh stations, access control units, data entry terminals, and tank farm management systems, as well as other devices.

Batch loading of liquid and/or gaseous products are provided at petroleum refineries, dairy product distribution facilities, fertilizer manufacturing facilities, and chemical processing facilities, for example. The liquid and/or gaseous materials may include motor oil, diesel fuel, gasoline, liquid petroleum gas (LPG), milk, and a wide variety of other materials.

### SUMMARY OF THE INVENTION

A software interface is provided as an abstraction layer between field electronic devices of various protocols for communication with application layers of a supervisory control system. The software interface allows communication and control between a wide variety of device protocols and the supervisory control system.

### BRIEF DESCRIPTION OF THE DRAWINGS

FIG. 1 is a functional block diagram of a high level view of the field abstraction layer between control application components and devices;

FIG. 2 is a functional block diagram showing the architecture of the present field abstraction layer;

FIG. 3 is a flow chart showing a start-up sequence of the field abstraction layer;

FIG. 4 is a flow chart of the field abstraction layer command management and execution;

FIG. 5 is a flow chart of data cache management according to the present field abstraction layer; and

FIG. 6 is a functional block diagram of a system utilizing the present field abstraction layer.

### DETAILED DESCRIPTION OF THE PREFERRED EMBODIMENTS

The following descriptions set forth exemplary embodiments without limitation to the scope of the present invention.

The present field abstraction layer may be plugged into any control system application and to any field device for communication therebetween. The process control application controls various devices in the process area including devices which may be from different vendors and of different types so that the field abstraction layer accommodates a wide variety of different devices.

According to a first embodiment, the high level application is not altered yet permits the addition of new devices. The number of devices for interconnection and the type of devices and the connectivity of the devices is highly configurable according to an embodiment of the field abstraction layer. The protocol drivers of the components are upgradeable without making modification to the application program.

Connection of the devices may be accomplished in a variety of ways including through terminal server ports or directly to communication ports of an application machine. In one aspect, the field abstraction layer interfaces through a SCADA (supervisory control and data acquisition) system. The interaction with the high level application is independent of the SCADA system that is in place. The interaction with the field devices may be either by direct control of the device or by collecting data from the device at predetermined intervals.

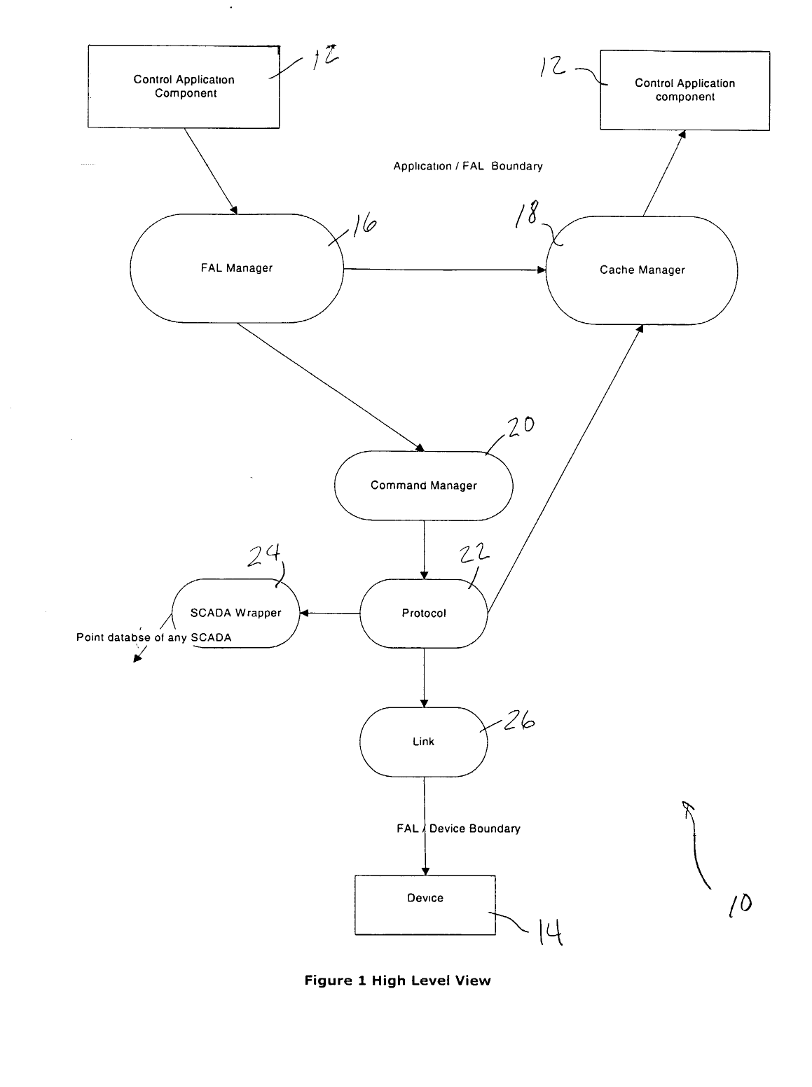

Referring to FIG. 1, a high level abstraction view of the field abstraction layer 10 is provided showing its connection between control application components 12 and a field device 14, for example. According to the embodiment of FIG. 1, the control application components 12 access the field abstraction layer 10 at a field abstraction layer manager 16 for the following functions,

1. To Perform device Operation Request,

2. To Receive data update event,

3. To enable/Disable polling of attribute,

4. To enable/Disable link/Device, and

5. To start/Shutdown the Field access layer.

The control application components 12 also access the cache manger 18, thereby to read values from the real time database maintained by the field abstraction layer in a group or individually. The field abstraction layer manager 16 is in communication with a command manager 20 that is, in turn, in communication with a protocol function component 22. The protocol function component 22 communicates with the cache manager 18 as well as with a SCADA wrapper component 24, if the SCADA system is used, as well as communicating with a link component 26 to the field device 14.

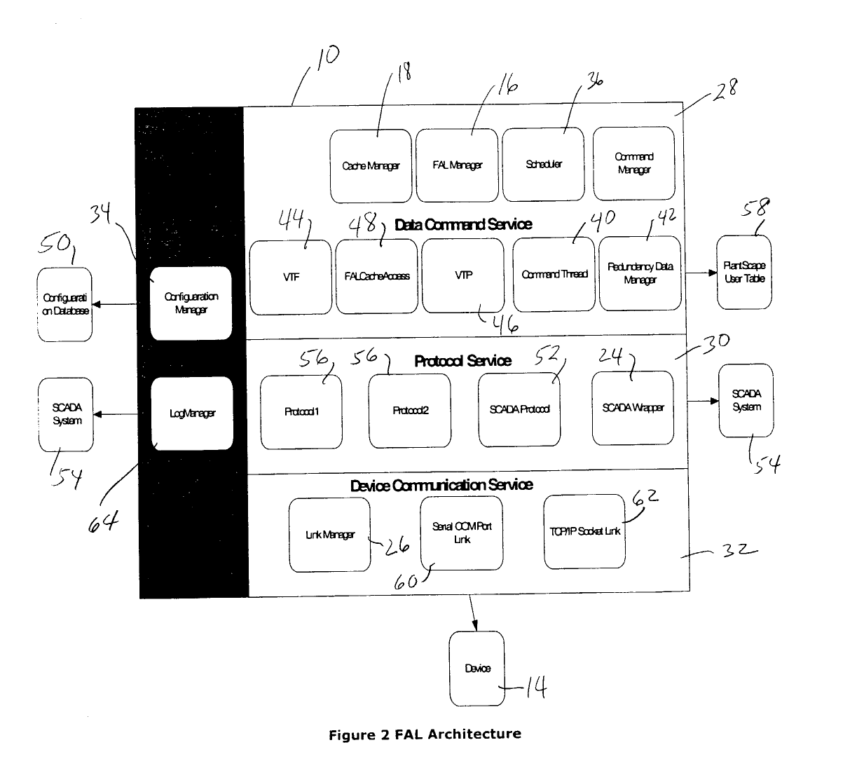

Referring to FIG. 2, the field abstraction layer 10 has an architecture constituting multiple logical layers. A first layer 28 is a data and command service logical layer, the second layer 30 is a protocol service layer, and the third layer 32 is a device communication service layer. These layer components get the configuration information from the database or persisted data set using a configuration manager 34 and a log manager 36 for logging the communication packets and other debugging information. The configuration manager 34 provides all the configuration information for all of the components of the field abstraction layer 10. The configuration manager 34 executes a stored set of procedures using, in a preferred embodiment, an SQL server operational system to return the following set of related configuration definitions as an ADO (active data object) disconnected record set. The configuration definitions include a polling configuration, a command table configuration, a link configuration, a protocol configuration, a cache attribute configuration, a VTF (value transformation) configuration, and a VTP (value transportation) configuration. To support redundancy in the system, the configuration manager 34 persists the ADO record set containing the configuration details in a SCSI disk in a binary format, for instance as an IPersistStream file.

In the data and command service layer 28, various components are provided, including the cache manager 18 and the field abstraction layer manager 16 as shown in FIG. 1, a scheduler 36, a command manager 38, a command execution thread 40, a redundancy data manager 42, a value transformation component 44, a value transportation component 46, and a cache access component 48. In further detail, the field abstraction layer manager 16 initializes and manages all the components in the field abstraction layer 10.

In one embodiment, the field abstraction layer manager 16 is provided in the Microsoft Windows 2000 operating system in one embodiment. For example, the field abstraction layer 10 of the present invention may run on a notebook computer or other computing device along with the control system application 12. The field devices 14 which are connected through the abstraction layer 10 to the control system application 12 include, for example, flow meters.

The field abstraction layer manager 16 exposes the interface for upper layer components which are components of the control application 12 so that the field devices 14 may be monitored and controlled. The field abstraction layer 10 conveys the results of the commands and data of interest to the application components. The field abstraction layer manager 16 initiates and stops the polling of certain attributes based on requests from the upper layers, or control layers, by forwarding requests to the scheduler component 36. For example, certain parameters such as flow rate are to be polled during a loading operation at fixed intervals in the case of a batch operation truck loading at a terminal automation system.

The scheduler component 36 of the data and command service layer 28 schedules the polling commands by loading the interval for each of the attributes from the configuration manager 34 and by phasing the intervals. The scheduler 36 utilizes the Microsoft Windows 2000 timer queue to provide the phased intervals, since its supports thread polling of its own. The attributes can be scheduled to poll at configured intervals and, based on this interval, the set of attributes to be polled will be decided on each phased time interval, also referred to as a tick interval. The scheduler 36 puts polling commands for the attributes that are to be polled at every phased timer callback into the command table. The polling type for each attribute is defined in the configuration database 50. The polling types include intermittent polling, continuous polling or no polling. Continuous polling provides that the attribute commands shall be updated to the command table for every phased polling interval during the complete life cycle of the scheduler component 36. In accordance with intermittent polling, the attribute commands are updated to the command table only on enabling of the attribute by calling the start polling operation through the field abstraction layer manager 16 and the stop polling operation to disable back the attribute polling. The default command for the device is polled to avoid the device switching over from remote to local, and this is triggered by the higher layer.

The command manager component 20 executes device level calls in monitoring and controlling of the field device 14, the device level calls being formatted to the field abstraction layer command structure. The command manager manages all the commands to be executed by the field abstraction layer. In particular, the command manager 20 dispatches the commands to the protocol threads whenever a request for execution of a command for a device 14 is issued.

The following information is input for execution of a command: attribute identification, command string, device identification, and parameter array. The protocol component 22 looks up the command identification and the respective device command whenever the command string or attribute identification is passed with the field abstraction layer command structure.

According to a command type 1, if the attribute is to be queried by a regular device protocol component, then the attribute identification of the field abstraction layer command structure is used to look up the device command. The protocol component 22 packs and unpacks the data from and to the field device 14 using the device specific protocol driver component, which is to be instantiated with the program identification configured for the corresponding device type.

According to a command type 2, if the command has to be executed by a SCADA protocol component 52, then the command string or the attribute corresponding to the command identification will be equivalent to a command “ReadParam” or “WriteParam” which is to be executed through the SCADA layer through the SCADA wrapper component 24 to the SCADA system 54.

According to a command type 3, for a command which is of the type “Do something” that is directed to the field device 14 has the command string which is specified in the field abstraction layer command structure. For instance, the command may for example, be “StopBatch”.

The following are the configuration tables for mapping the high-level commands to attributes and to the low-level command strings.

TABLE 1

| | | | | Polling | | | Device |
|---|---|---|---|---|---|---|---|
| | Device | Data | Read/ | Interval | Auto- | Command | attribute- |
| Attribute | Type ID | type | Write | (in secs.) | Polling | ID | Address |
| Open Gate | SCADA | Bool | W | — | 0 | — | — |
| Display | Contrec | String | W | 60 | 0 | 1201 | — |
| Message | | | | | | | |
| ESD | SCADA | BOOL | R/W | 30 | 1 | — | — |
| BCU Stop | Contract | Bool | R/W | 30 | 0 | 1202 — | |
| RIT status | Contract | Tnt | W | — | — | — | — |

TABLE 2

| | Point | Parameter | Command |
|---|---|---|---|
| Point ID | name | Name | String |
| OpengatePnt | Psgtopen1 | OP | WriteParam |
| Esdpnt1 | Esd1 | PV | ReadParam |

TABLE 3

| Point | Point | Parameter | Command |
|---|---|---|---|
| ID | name | Name | String |
| OpengatePnt | Psgtopen1 | OP | WriteParam |
| Esdpnt1 | Esd1 | PV | ReadParam |

The point column of Table 3 may contain either the PlantScape PointID or the “UST,Rec,Word” string, then the command shall be formatted to call either the User table Read/Write function or Point.Param read/write function.

TABLE 4

| Point ID | Device |
|---|---|
| OpengatePut | Gate1 |
| Esdpnt1 | ESD1 |

Command Table structure

| | | | | | | | | | |
|---|---|---|---|---|---|---|---|---|---|
| | | | Current | | | | | | |
| | | | SubCmd | | | | | | |
| Device | | | Sequence | Parameter | | Time | Command | | |
| ID | Link | AttributeID | Number | array | Priority | stamp | Source | Handle | Status |

If the command identification is already in queue for the device in the command table, then the subsequent command is ignored. For example, when the protocol supports multiple attributes for a single command, the query is made only once.

The value attributes which are not read from the device are cached and stored in the database. For example, these may include the RIT status and display message. A redundant server loads the values of all virtual attributes from the database into the cache during the switch over from the redundant server to the primary server. The virtual attribute is differentiated from the other attributes when the lsvirtual for the attribute is true for the database. The virtual attribute is differentiated from the other attributes when the attribute lsvirtual is in the database.

TABLE 5
Virtual attribute table

| | | |
|---|---|---|
| Attribute | DeviceID | Value |

The command execution thread element shown in FIG. 2 is a thread function which executes the protocol component for each link. A link may be a terminal server port or a COM port. The thread function is part of the field abstraction layer manager 16. The thread function is initialized with the protocol component interface during creation.

One thread is created per link and each thread picks up commands meant for the field devices 14 on the link with the help of the command manager 20 and executes them in sequence. Any high priority commands will be executed and then the lower priority commands are executed. The thread executes each command with the help of the corresponding protocol driver component 56.

Also provided in the data and command service layer shown in FIG. 2 is the redundancy data manager 42. The command manager component 20 updates the additional command table that is maintained in the Redundancy user table 58 (which is provided in the SCADA depending upon the intermediate storage format). This command table is maintained for redundancy purposes for availability of the command execution status to the secondary machine, also termed the Takeover machine. The redundancy data manager 42 masks the dependency of the command manager 20 from the PlantScape user table 58 for easier migration to the control application redundancy table from the user table. The redundancy data manager 42 may be modified to talk to a different redundancy storage mechanism later without disturbing the command manager 20.

The value transformation (VTF) component 44 of the data and command service layer 28 is a C++ class component which is used by the cache component 48 to perform the raw value transformation based on the criteria defined for the attribute. The steps for performing the value transformation include; 1) lookup the attribute, index and device in the lookup table prepared from the table 6 shown below. 2) If the attribute is available in the lookup table then then the criteria identification from the table 6 is selected. 3) For the selected criteria identification, the condition is applied from the table 7 shown below with the compared value. Subsequently, the return value is compared with the compared value and when the subsequence value matches with the number of sequences in table 6 for the criteria, the return value is checked with the transformation value. 4) If the return value and the transformation value are equal then the transformation is applied by changing the raw to a destination value.

TABLE 6

| | | | | Number | Source | | |
|---|---|---|---|---|---|---|---|
| | Source | | | of | Attribute | Destination | Destination |
| DeviceID | Attribute | CriteriaID | Index | Sequences | value | Attribute | Value |
| RIT12 | Green | 1001 | 1 | 1 | 1 | Green | Green ON |
| | Button | Button | | | | | |
| RIT12 | Green | 1002 | 1 | 1 | 0 | Green | Green |
| | Button | Button | OFF | | | | |
| BCU12 | Flow rate | 1003 | 1 | 1 | 1 | Flow Status | Flowrate_Exceeded |
| BCU12 | Flow rate | 1004 | 1 | 2 | 1 | Flow Status | Flowrate_Normal |

TABLE 7

| | | | Compared |
|---|---|---|---|
| CriteriaID | Subsequence | Condition | value |
| 1001 | 1 | EQ | 1 |
| 1002 | 1 | EQ | 0 |
| 1003 | 1 | GR | 1200 |
| 1004 | 1 | LS | 1000 |
| 1004 | 2 | GR | 400 |

The value transportation (VTP) configuration component 46 of the data and command service layer 28 is performed with the configuration tool and stored in the database. The value transportation configuration is loaded into the memory in a lookup format during initialization. The steps for transportation are as follows:

1. Check if the attribute value is equal to the transportation value whenever the criteria is satisfied, and then obtain the transportation identification and the number of the subsequence from table 8 shown below.

2. Request the command manager 20 to update the command table with each of the subsequence command strings from the table 9, shown below.

TABLE 8

| | | | Transportation | Number of |
|---|---|---|---|---|
| DeviceID | Attribute | TransportationID | Value | Sequences |
| ESD1 | ESD | 001 | 1 | N |

TABLE 9

| Trans- | Sub- | | | | | |
|---|---|---|---|---|---|---|
| portation | sequence | | Device | Command | Para- | |
| ID | number | Attribute | ID | String | meter | Priority |
| 001 | 1 | 1201 | BCU1 | | | 1 |
| 001 | 2 | 1201 | BCU2 | | | 1 |
| 001 | . . . | . . . | . . . | | | . . |
| 001 | N | OpenGate | Gate1 | | 1 | 1 |

The mapping of the command string for the above transportation steps to be executed is provided in accordance with the command mapping table shown as table 9 set forth in the discussion of the command manager above.

The cache manager element 18 manages the device data cache and transmits the change of the data event to the field abstraction layer manager 16 for the attribute whose report column data in the Device-Attribute table is greater than 0. Before updating the cache with the attribute value, the value transformation is performed and on updating of the cache, the value transportation is performed with the VTP component 46. If the attribute report is one, then the attribute value is reported to the application layer component 12 through the field abstraction layer manager 16 whenever the attribute value changes. If the attribute report is two, then the attribute value is reported to the application layer component 12 through the field abstraction layer manager 16 irrespective of the change in the attribute value. Each row of the data cache is mapped to each device 14, index and attribute containing the value and the timestamp.

With reference to FIG. 2, the protocol service logical layer 30 includes protocol components 56. The protocol service is provided by a set of protocol components 56 which are written for specific devices but which provide a common interface. The progID command for each protocol type component 56 having a common interface is configured and stored in database for each device type. The command execution thread component executes the command with a generic protocol and a corresponding device driver component.

The protocol component 22 maps the incoming command string into the protocol command and calls the link component 26 to read/write the passing device identification. A timeout and retry operation for each command is pre-configured in the database and is used to timeout or retry, respectively, by the protocol component 22 during the command execution.

A device communication failure is declared as failed whenever a barometer level for the device goes above the threshold limit.

Also with reference to FIG. 2, the device communication service logical layer 32 provides a communication to the device. For dual-port devices, a primary port is configured for communication and a second port is configured as a standby communication port. Reading/writing of data is performed only on a primary port for a machine. The standby communication port is used only when the primary port has failed or has been manually disabled. The device communication service layer 32 includes the link manager component 26 and link components 60 and 62. In the illustrated example, a serial COM port link 60 is provided as well as a TCP/IP socket link 62.

In particular, the link component layer 32 supports both the serial COM support communication protocol and the TCP/IP socket communication protocol with the terminal server. The protocol component 56 creates a communication link component instance in the pool with connection configuration information of the device. If a set of devices is multi-dropped to a link, than the protocol objects handling these devices will share the communication objection handling that link.

The link configuration information, including such information as Baud-rate, Parity and any other parameter, is maintained as a string as part of the configuration data in the database. This information is loaded into the link component 26 during the start up to connect to the device during the initializing phase. If the primary link fails, then the secondary link is used to communicate to the device. If the secondary device also fails, then the device becomes disabled and a manual reset operation is required to resume the communication. All communication errors are logged by a log manager 64 into the SCADA system 54. The link component 26 does not expose any asynchronous methods. A barometer threshold limit is defined for link switch-over.

A redundancy manager 42 triggers the field abstraction layer manager 16 for any change in the state of operation. The loss of the primary status to the SCADA server signals the field abstraction manager 16, the command manager 20, and the link manager 26 to switch over as a backup. In this regard, the following steps are performed:

1. The link releases the entire communication handle held by closing the connection.

2. The field abstraction manager 16 stops the scheduler 36 and the incoming calls.

3. The command manager 20 stops executing the command from the command table and clears the command table.

Taken in reverse, a change of SCADA server from the backup function to a primary function signals the field abstraction manager 16, and the link manager 26 to switch over as the primary. The following steps are performed in this regard:

1. The configuration from the binary format (ADTG) file created by the configuration manager 34 in the SC ( supervisory control ).

2. The link connects to all the devices 14 and gets the communication handle.

3. The command manager 20 copies the commands from the user table to the command table and starts executing the commands according to the priority and the time stamp.

4. The field abstraction layer manager 16 starts the scheduler 36 for polling and executes the incoming calls.

5. The virtual attributes are loaded from the database to the field application layer data cache memory 18.

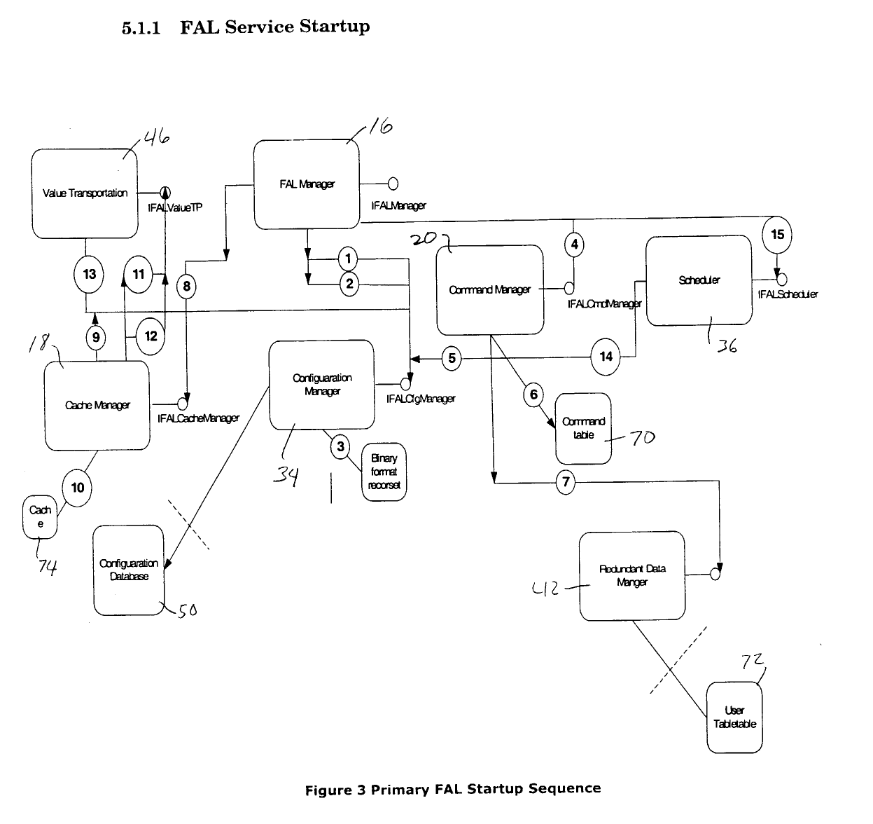

Referring to FIG. 3, the primary field application layer start-up sequences shown. The field application layer manager performs the following in sequence upon start-up of the primary field application layer service.

1. An instance of the configuration manager component 34 is created.

2. The configuration manager 34 is instructed to load the configuration.

3. The configuration manager 34 persists the configuration in a binary format (ADTG) file in the SCSI disk.

4. An instance of the command manager component 20 is created.

5. The command manager 20 is instructed to load the configuration from configuration manager 34.

6. The command manager 20 instructed to create in memory structures, such as in a command table 70, from the number of devices for each device type.

7. The command manager 20 creates an instance of the redundancy manager 42 and connects to the PlantScape server for accessing the user table 72.

8. An instance of the cache manager component 18 is created.

9. The cache manager 18 is instructed to load the configuration from the configuration manager 34.

10. The cache manager 18 is instructed to create an in memory structure, such as in a data cache table 74.

11. The cache manager 18 creates an instance of the VTP component 46.

12. The cache manager 18 calls the VTP component 46 to load the configuration from the configuration manager 34.

13. The command thread is created for each link.

14. The command thread creates the protocol component 22 and the respective device type driver component and performs a connecting operation to the device.

15. The thread information is passed for each command thread into the command manager component 20.

16. The scheduler thread is created.

17. The scheduler configuration is loaded in from the configuration manager 34 and phase polling.

18. The scheduler 36 is instructed to start polling.

The field abstraction layer manager 16 performs the following sequence upon start-up of the field abstraction layer service in the secondary.

1. An instance of the configuration manager component 34 is created.

2. The configuration record set is loaded from the shared disk.

3. An instance of the command manager component 20 is created.

4. The command manager 20 is called to load the configuration from the configuration manager 34.

5. The command manager 20 is called to create in memory structures, such as a command table 70, from the number of devices of each device type.

6. The command manager 20 creates an instance of the redundancy manager 42 and connects to the PlantScape server for accessing the user table 72.

7. An instance of the cache manager component 18 is created.

8. The cache manager 18 is called to load the configuration from the configuration manager 34.

9. The cache manager 18 is called to create an in memory structure, such as a data cache table 74.

10. The cache manager 18 creates an instance of the VTP component 46.

11. The cache manager 18 calls the VTP component 46 to load the configuration from the configuration manager 34.

12. A command thread is created for each link.

13. The command thread creates the protocol component 22 and waits for the switchover as a primary event from the redundancy manager 42.

14. The thread information is passed for each command thread into the command manager component 20.

15. The scheduler thread is created.

16. The scheduler configuration is loaded from the configuration manager 34 and phase polling.

17. Wait for the switchover to the primary event in the scheduler thread for starting the polling from the redundancy manager 42.

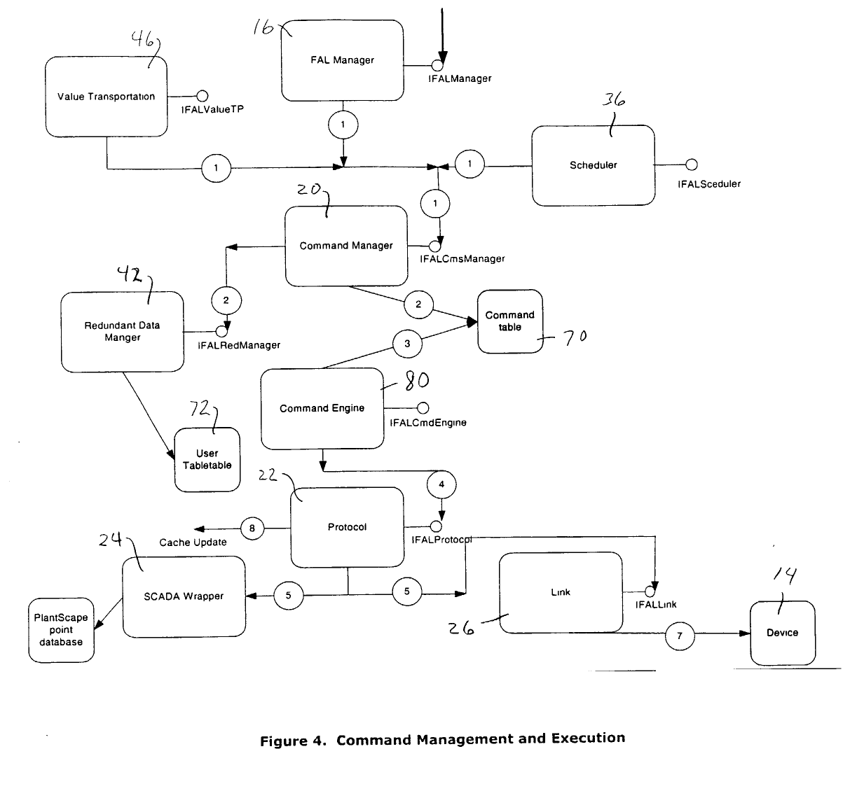

In FIG. 4 is shown a command management and execution diagram. According to this diagram, the command execute request is received by the command manager 20 from either the scheduler 36 or the field application layer manager 16 or the VTP 46. Next, the command manager component 20 maps the attribute and parameter to sub commands and updates the command table with the command string or the attribute identification along with the parameter array pointer and in case of a user table 72, the parameter array is stored as a comma separated string. Thereafter, the command manager 20 updates the command table 70 in both the PlantScape user table 58 and the command table 70 in memory. Next, command thread component 80 creates one thread per port and each thread executes the command request for the device in that link. If the protocol is SCADA, then the value to point parameter is set or read. Lastly, the protocol component 22 maps the command string into protocol specific commands and sends a write or read request to the respective link component 26.

Cache management is handled according to the following.

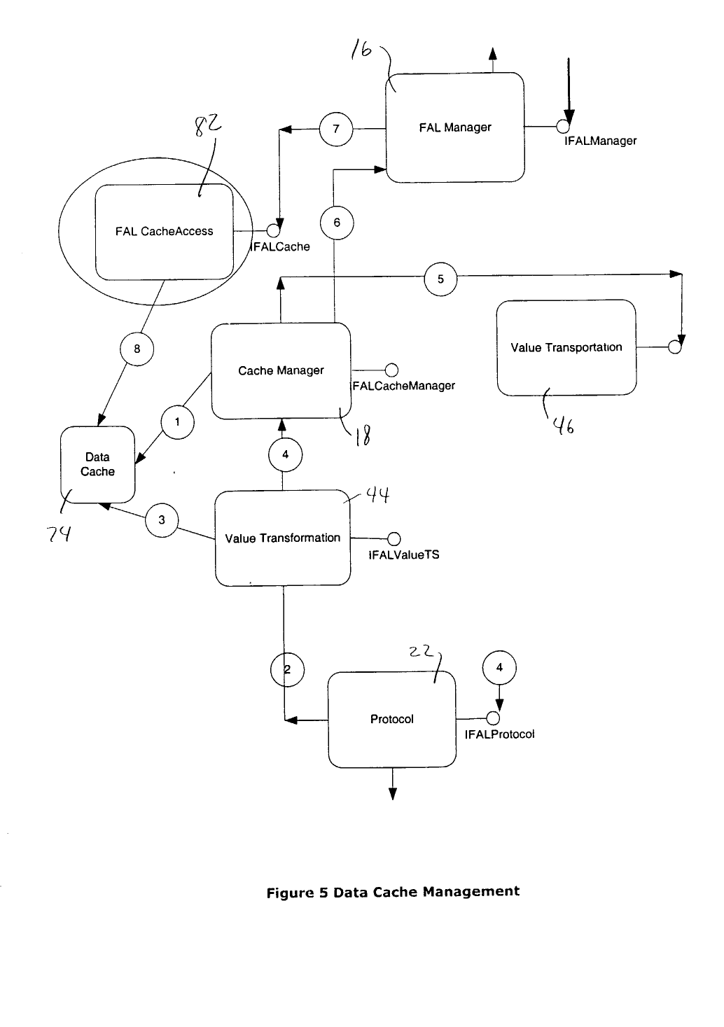

First, the cache lookup is created by the cache manager 18 with the configuration details that are available. After executing the command, the protocol component 22 returns the value of the attribute to the cache after transforming. If the value of the attribute is changed, then the data is passed as an event to the field abstraction layer manager 16 for transmission to the upper layer and performance of the value transportation. The value transportation is performed if the attribute is defined for transportation. The data change event is transferred to the field abstraction layer manager 16. The field abstraction layer manager 16 reports to the application Event manager with the attribute ID and value depending on the reporting option configured for the attribute and this may be continuous or on exception based. The field abstraction layer cache access component 82 reads the required data with the device identification, attribute identification and index as the key from the cache manager. These features are shown in further detail in FIG. 5.

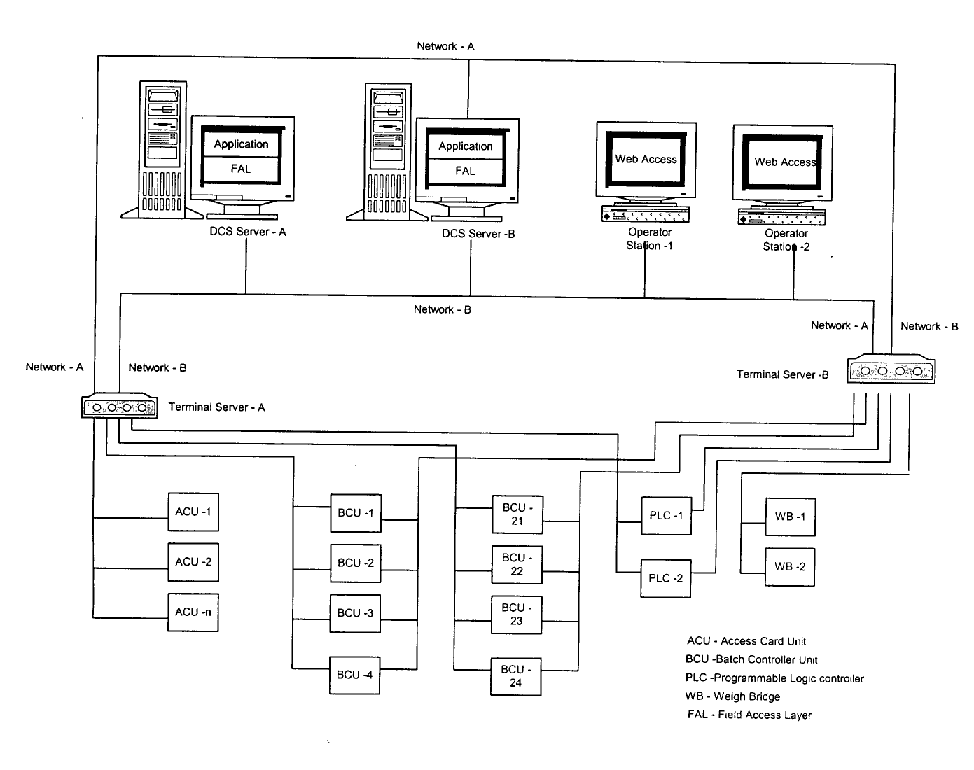

FIG. 6 shows an example of a networked system utilizing the present field abstraction layer. The system includes two DCS servers running the field abstraction layer application, and a pair of operator workstations, each connected to a network B. The network B is also connected to a pair of terminal servers. A further network A is connected to the terminal servers and one of the DCS servers. The terminal servers are connected to several access card units ACU, several batch controller units BCU, programmable logic controllers PLC and weigh bridges, or weigh stations, WB. The batch controller units BCU and programmable logic controllers PLC are each connected to both of the terminal servers, whereas the access card units ACU and weigh bridges WB are only connected to one respective terminal server. The present system is provided at a terminal for transport of bulk materials, for example, and so monitoring and control of the bulk material transfer is provided.

Thus, there is shown in a field abstraction layer for interface between various components in a bulk materials transport system.

Although other modifications and changes may be suggested by those skilled in the art, it is the intention of the inventors to embody within the patent warranted hereon all changes and modifications as reasonably and properly come within the scope of their contribution to the art.

We claim:

1. An interface level for a monitoring apparatus for bulk materials handling, comprising;
a link to a field device;
a command manager connected to said link;
a field abstraction layer manager connected to said command manager, said field abstraction layer manager connected to a control application component.

2. An interface level as claimed in claim 1, further comprising:
a protocol component connected between said command manager and the field device;
a cache manager connected to said protocol component, said field abstraction layer manager being connected to said cache manager, said cache manager being connected to a second control application component.

3. An interface level as claimed in claim 2, further comprising:
a SCADA wrapper component connected to said protocol component.

4. An interface level as claimed in claim 1, wherein said link includes a serial COM port connection.

5. An interface level as claimed in claim 1, wherein said link includes a TCP/IP socket connection.

6. An interface level as claimed in claim 1, wherein said field abstraction layer manager exposes said control application component to monitor and control the field devices and to transfer command results and data of the field devices to said control application component.

7. An interface level as claimed in claim 1, further comprising: a scheduler component in communication with said field abstraction layer manager and operable to set polling of the field device.

8. An interface level as claimed in claim 1, wherein said field device is a flow control monitor to monitor movement of bulk materials.

9. An interface for a monitoring apparatus for bulk materials handling, comprising:
a first level being a data and command service layer;
a second level being a protocol service lay; and
a third level being a device communication service layer.

10. An interface as claimed in claim 9, wherein said data and command service layer includes a cache manager and a command manager and a field abstraction layer manager.

11. An interface as claimed in claim 10, further comprising:
a value transformation component and a value transportation component.

12. An interface as claimed in claim 9, wherein said protocol service layer communicates with a SCADA system, said protocol service layer including a SCADA protocol component and a SCADA wrapper.

13. An interface as claimed in claim 9, further comprising: a redundancy component

14. An interface as claimed in claim 9, further comprising:
a configuration manager providing all configuration information for components of the interface.

15. An interface as claimed in claim 14, wherein said configuration manager provides a configuration record set that includes at least one of the following items of information: polling configuration, command table configuration, link configuration, protocol configuration, cache attribute configuration, virtual transformation configuration, and virtual transportation configuration.

16. A method for linking a command application to at least one field device, comprising the steps of:
abstracting hardware devices to a higher layer
forwarding commands between a command layer and a field device

17. A method as claimed in claim 16, wherein said high level application communicates with the field device independent of the SCADA system.

18. A method as claimed in claim 16, wherein said communication between said field device is in real time.

19. A method as claimed in claim 16, wherein said communication between said field device is at configured intervals.

20. A method as claimed in claim 16, further comprising the step of:
executing a protocol component by a thread function for each communication link to a field device, one thread function being created for each link and the thread picks up commands for each device on the link and executes the commands in sequence.

21. A method as claimed in claim 16, further comprising the steps of:
for a first command type,
looking up device command for an attribute to be queried by a regular device protocol component using an attribute identification in a field abstraction layer command structure;
packing data transferred between the field device and the command component using a protocol component;
for a second command type,
executing a command through SCADA using a SCADA wrapper component is the command is to be executed by a SCADA protocol component;
for a third command type,
specifying a command string in the field abstraction layer command structure for commands instructing the device to do something.

22. A method as claimed in claim 16, farther comprising the steps of:
performing a value transformation including,
looking up an attribute in a look up table for the field device,
selecting an identification if the attribute for the field device is in the look up table,
applying a condition and a compared value depending on the identification,
comparing a return value with the compared value,
checking the return value with a transformation value when a sub sequence matches a number of sequences for the criteria, and
applying a transformation to change a raw value to a destination value if the return value and transformation value are equal.

23. A method as claimed in claim 16, further comprising the steps of:
performing a value transportation, including
obtaining a transportation identification and sequence number depending on an attribute value; and
updating a command table with each subsequence command string.

24. A method as claimed in claim 16, further comprising the steps of:
providing link configuration information for each field device, and
loading the link configuration information for the field device that is connected to the field abstraction layer.

25. A method for abstracting communications between at least one field device and a command layer, comprising the steps of:
creating an instance of a configuration manager;
calling the configuration manager to load a configuration;
creating an instance of a command manager;
calling the command manager to load the configuration of the configuration manager;
creating a command table structure in memory for each device type of the field devices;
creating an instance of a cache manager;
calling the cache manager to load the configuration of the configuration manager;
creating a data cache table structure in memory;
creating an instance of a virtual transportation component;
calling the virtual transportation component to load the configuration of the configuration manager;
creating a command thread for each link to the at least one field device;
creating a protocol component and device type driver component and connecting to the at least one field device using the command thread;
passing command thread information to a command manager;
creating a scheduler thread;
loading a scheduler configuration into the configuration manager; and
calling the scheduler to begin polling of the at least one field device.
